(19) United States
(12) Patent Application Publication
(10) Pub. No.: US 2009/0120915 A1
(43) Pub. Date: May 14, 2009

(54) METHOD FOR MAKING AIRTIGHT CONTAINER

(75) Inventors: Masahiro Tagawa, Isehara-shi (JP); Kosuke Kurachi, Kawasaki-shi (JP); Nobuhiro Ito, Yamato-shi (JP); Akihiro Kimura, Yokohama-shi (JP); Yasuo Ohashi, Hadano-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/264,408

(22) Filed: Nov. 4, 2008

(30) Foreign Application Priority Data
Nov. 13, 2007 (JP) 2007-294266

(51) Int. Cl. B23K 26/08; B65B 51/10; B23K 26/32

(52) U.S. Cl. 219/121.62; 219/121.76; 219/121.8; 53/477

(57) ABSTRACT

A laser beam emitted from a laser oscillator unit passes through a first substrate and irradiates a sealing member. The sealing member irradiated with the laser beam is heated in accordance with the absorptance and thus softens and melts. The laser beam is reflected by the sealing member and the reflection reaches a detector unit. A computing unit transmits information, such as a correction value of the laser power, to a laser controlling unit on the basis of the information from the detector unit so that the melting state of the surface of the sealing member is kept constant. In this manner, the melting state of the sealing material can be maintained in an appropriate state.

### BACKGROUND OF THE INVENTION

1. Field of the Invention

The present invention relates to a method for making an airtight container.

2. Description of the Related Art

According to a typical method for making an airtight container, a joining member is provided between a first substrate and a second substrate and irradiated with a laser beam so that the joining member becomes molten and a peripheral portion of the first substrate is thereby joined to a peripheral portion of the second substrate.

In such a method for making an airtight container, the state of control of the laser beam that melts the joining member greatly affects the airtightness of the container. There have been many proposals of laser control suitable for different types of objects to be irradiated.

United States Patent Application No. 2005/0199599 ('599 document hereinafter) (see paragraph [0031] and FIG. 2) describes a technique of detecting the distance from the laser source to a laser-irradiated object and information of the laser energy on the basis of reflections from a surface of a glass package or organic electro-luminescence (OEL) diode and changing the laser intensity and the distance from the laser source to a laser-irradiated object on the basis of the detected information.

United States Patent Application Nos. 2006/0082298 ('298 document) (see paragraph [0039] and FIG. 8) and 2006/0084348 ('348 document) (see paragraph [0039] and FIG. 8) describe a technique of monitoring the temperature of a laser-irradiated object from the intensity of reflections and controlling the laser scanning rate and the laser intensity so that the temperature of the laser-irradiated object is kept constant.

Japanese Patent Laid-Open No. 08-250021 ('021 document) discloses a technique of laser-processing a workpiece having steps thereon, in which a laser beam is split so that one beam is used for measuring the height and the other beam is used to process the workpiece while receiving feedbacks of the height information.

According to the method of fabrication of hermetically sealed package described in '599 document, a laser beam having a wavelength different from that of a laser beam for processing is applied to a workpiece from a diagnostic system, and information regarding the laser power and information regarding the distance to the workpiece are determined based on reflections from the surface. However, the '599 document does not disclose what information regarding the reflected laser beam is used in controlling the laser power, thereby rendering the description ambiguous.

In the method for making a sealing container described in '298 document and '348 document, the power and scanning rate of the laser are controlled to keep the temperature of the joining member heated by laser irradiation constant. However, depending on the condition of the joining member, the joining member may not sufficiently melt even when the irradiation temperature is constant to achieve airtightness continuously over the entire joining portion. For example, in the case where there is nonuniformity in thickness of an oxide film formed on the surface of the joining member, the oxide film may not dissipate even when the joining member is heated to its melting temperature, which renders it difficult to keep airtightness continuously over the entire joining portion. Such a state may also occur depending on the shape of the surface of the joining member.

According to the method described in '021 document, in laser-processing a workpiece having steps thereon, a laser beam is split so that one beam is used for measuring the height. However, this method is not a method that can continuously keep airtightness while monitoring the melting state of the laser-irradiated portion.

In all of the patent documents described above, it is difficult to continuously keep the substrates and the joining member closely adhered to each other, and airtightness has not always been achieved. Thus, a production method that can more stably ensure airtightness of the container has been desired.

To be more specific, according to a method for making an airtight container by joining a pair of substrates with a joining member, gaps (contact failure) are created between the joining member and the substrates due to the thickness nonuniformity and/or the surface condition of the joining member. In joining a substrate to a frame member (or another substrate) by heat-melting the joining member through the substrate, these gaps obstruct heat transmission to the joining portion. As a result, the melting state of the joining member becomes different from one position to another, and the joining member does not uniformly adhere to the substrate. Accordingly, in the process of heat-melting the joining portion, it is desirable to have the joining member continuously adhered onto the substrate in order to improve the airtightness of the container.

### SUMMARY OF THE INVENTION

The present invention improves airtightness of a container by keeping constant the melting state of the joining member induced by laser.

An embodiment of the present invention provides a method for making an airtight container including a first substrate, a second substrate, and a frame member. The methods includes steps of irradiating a sealing member disposed between the first substrate and the frame member with a laser beam; determining a melting state of the sealing member on the basis of a reflection of the laser beam reflected by the sealing member; and joining the first substrate to the frame member with the sealing member by controlling laser energy of the laser beam incident upon the sealing member per unit area based on a determination of the melting state of the sealing member.

According to the present invention, airtightness of an airtight container including two substrates and a frame member sandwiched between the substrates can be improved.

Further features of the present invention will become apparent from the following description of exemplary embodiments with reference to the attached drawings.

### BRIEF DESCRIPTION OF THE DRAWINGS

FIG. 1 is a schematic diagram illustrating an example method for making an airtight container.

FIG. 2 is a graph for explaining the example method.

FIG. 3 is another graph for explaining the example method.

FIG. 4 is a diagram illustrating Example 2.

FIG. 5 is a diagram illustrating Example 3.

FIG. 6 is a diagram illustrating Example 4.

FIG. 7 is a perspective view, partially cut away, of an image forming apparatus.

### DESCRIPTION OF THE EMBODIMENTS

Embodiments of the present invention will now be described with reference to the drawings.

An airtight container in the embodiments includes a first substrate, a second substrate, and a joining member disposed between the first and second substrates and surrounding the peripheries of the first substrate and the second substrate. Alternatively, a frame member disposed between the first and second substrates and surrounding the peripheries of the first substrate and the second substrate may be provided. In such a case, a first joining portion may be provided between the first substrate and the frame member and a second joining portion may be provided between the frame member and the second substrate.

The airtight container of this embodiment can be used in an image-forming apparatus. In particular, the present invention may be applied to an image-forming apparatus including the first substrate provided with a phosphor and an electron acceleration electrode and the second substrate provided with an electron source.

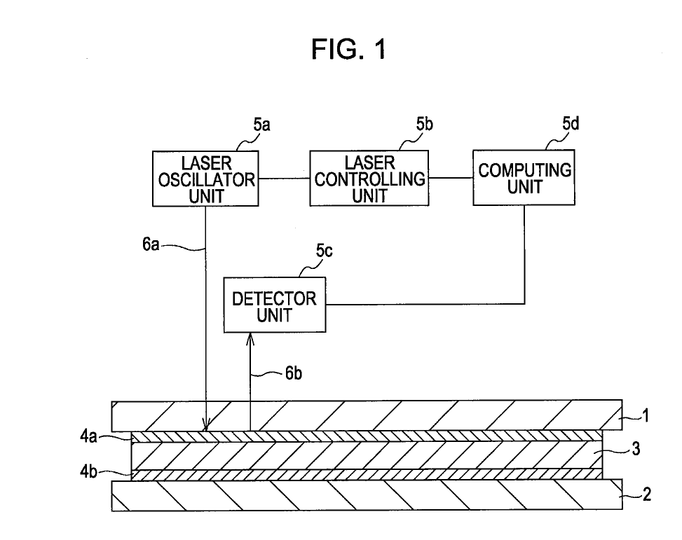

One embodiment of the invention will now be described with reference to FIGS. 1 to 3.

FIG. 1 is a schematic diagram illustrating an example method for making an airtight container.

The airtight container made by the method includes a first substrate 1, a second substrate 2, and a supporting frame 3 surrounding the peripheries of the first substrate 1 and the second substrate 2. The first substrate 1 and the second substrate 2 may be glass substrates. In order to fabricate an image-forming apparatus, phosphors and electron acceleration electrodes are formed on the first substrate 1, and electron sources are formed on the second substrate 2. The supporting frame 3 can be made of a material having a thermal expansion coefficient substantially equal to that of the first substrate 1 and the second substrate 2.

A sealing member 4a which serves as a joining member for joining the first substrate 1 to the supporting frame 3 is provided between the first substrate 1 and the supporting frame 3. A sealing member 4b which serves as a joining member for joining the second substrate 2 to the supporting frame 3 is provided between the second substrate 2 and the supporting frame 3.

The sealing members 4a and 4b used in this method can be composed of a material that has heat resistance sufficient for vacuum baking, airtightness that can maintain high vacuum, adhesiveness to other components, and low gas-releasing property.

A manufacturing apparatus for implementing the above-described method includes a laser oscillator unit 5a that is scanned while applying a laser beam to the sealing member 4a extending along the supporting frame 3; a laser controlling unit 5b that controls the power of the laser beam and the like; and a detector unit 5c that detects reflections from the sealing member 4a. Furthermore, the manufacturing apparatus further includes a computing unit 5d that transmits information such as correction values for laser power to the laser controlling unit 5b on the basis of the information from the detector unit 5c so that the melting state of the surface of the sealing member 4a can be kept constant.

In this manufacturing apparatus, a laser beam 6a emitted from the laser oscillator unit 5a passes through the first substrate 1 and irradiates the sealing member 4a. The temperature of the sealing member 4a irradiated with the laser beam rises in accordance with the absorptance, and the sealing member 4a softens and melts as a result.

The laser beam 6a is reflected by the sealing member 4a, and its reflection 6b reaches the detector unit 5c. The computing unit 5d transmits information such as a correction value of laser power to the laser controlling unit 5b on the basis of the information from the detector unit 5c so that the melting state at the surface of the sealing member 4a is kept constant. As a result, the melting state of the sealing member 4a can be kept in an appropriate state.

Note that “appropriate state” means a state in which a negligible amount or less of obstructing substance (e.g., an oxide film) that obstructs airtight joining of the first substrate 1 to the supporting frame 3 exists on the surface of the sealing member 4a.

Examples of the information transmitted from the detector unit 5c and used in the computing unit 5d include various types of information regarding reflections of the laser beam. Among these types of information, information regarding reflectance can be used in the computing unit 5d.

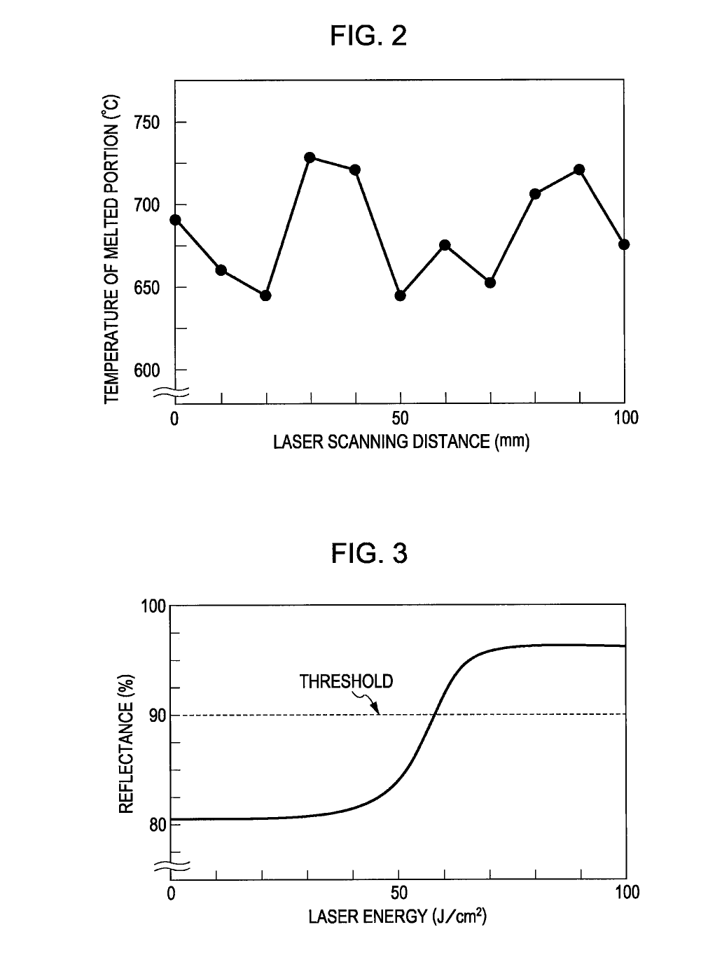

FIG. 2 is a graph showing the temperature of the portion of the sealing member 4a irradiated with the laser beam 6a while scanning. In order to keep the melting state of the sealing member 4a to an appropriate level, the energy of laser irradiation is adjusted on a real time basis; hence, the temperature differs depending on the position. This is due to the presence of nonuniformity in surface condition of the sealing member 4a. For example, there may be nonuniformity in thickness of a surface oxide film.

FIG. 3 is a graph showing the relationship between the energy of the irradiating laser and the reflectance. Increasing the laser energy increases the reflectance since the sealing member 4a melts. Thus, a threshold value of reflectance is set and the laser energy is applied so that the reflectance is greater than or equal to that threshold value so as to keep the sealing member 4a in an appropriate melting state.

In general, the reflectance tends to increase when the material melts. However, in the case where melting is accompanied by changes in the surface layer, this does not always apply and even a decrease in reflectance is sometimes observed. In such a case also, the sealing member 4a can be kept in an appropriate melting state by setting the threshold value for the reflectance and controlling the laser energy within the threshold value.

Examples of the laser used include a solid laser, a liquid laser, a gas laser, a semiconductor laser, and a free electron laser. A laser appropriate for the light absorptance of the joining member can be selected. A semiconductor laser, a YAG laser, and a carbon dioxide gas laser can be used.

The method for making an airtight container described above can be applied to methods for making organic LED displays, plasma display apparatuses, and electron beam display apparatuses. In particular, the method can be applied to a method for making an airtight container used in organic LED displays and electron beam display apparatuses since they require high airtightness.

As described above, according to this embodiment, the melting state of the sealing member can be detected from the information regarding reflections of the laser beam, and the laser energy, per unit area, of the laser beam for melting the sealing member 4a is controlled on the basis of the detected results. In this manner, the joining portion is ensured to be in a melted state and a decrease in airtightness caused by insufficient melting can be prevented.

Moreover, since the reflectance, which is one type of information for determining the melting state, can be measured real-time, the feedback to the laser energy is simple and the controllability of the laser energy is improved.

### EXAMPLES

The present invention will now be described by way of specific examples.

### Example 1

Example 1 of the present invention will now be described with reference to FIG. 1. Example 1 is related to a method in which a laser for melting the sealing member is also used for detecting the melting state of the sealing member. According to this example, only one laser oscillator unit is needed and thus the apparatus (mechanism) can be simplified.

In Example 1, glass substrates (PD200 produced by Asahi Glass Co., Ltd.) 300 mm×350 mm in size and 1.8 mm in thickness were used as the first substrate 1 and the second substrate 2. A frame having a rectangular shape in plan 280 mm×330 mm in size and 1.8 mm in thickness prepared from a glass substrate was used as the supporting frame 3.

First, the supporting frame 3 with the sealing member 4b applied thereon was disposed on the second substrate 2 and baked in an atmospheric furnace to join the second substrate 2 to the supporting frame 3 with the sealing member 4b. In this example, frit glass LS-7305 (produced by Nippon Electric Glass Co., Ltd.) was used as the sealing member 4b. In this example, the sealing member 4b was placed on the supporting frame 3 in advance but the arrangement is not limited to this. The sealing member 4b may be placed on the second substrate 2 in advance.

Next, the sealing member 4a was placed on the supporting frame 3 and the first substrate 1 was placed on the sealing member 4a. In this example, an aluminum foil having the same shape as the supporting frame 3 and a thickness of 0.05 mm was used as the sealing member 4a.

The first substrate 1 and the second substrate 2 were fixed with a fixing jig not shown in the drawing to keep the first substrate 1 and the second substrate 2 aligned.

The laser oscillator unit 5a was placed above the first substrate 1 so that the sealing member 4a on the supporting frame 3 could be irradiated with a laser beam. In this example, a semiconductor laser (wavelength: 808 nm) was used as the laser oscillator unit 5a and laser power was adjusted by controlling the making current value.

The laser beam 6a emitted from the laser oscillator unit 5a passed through the first substrate 1 and irradiated the sealing member (aluminum foil) 4a. The temperature of the sealing member (aluminum foil) 4a rose in accordance with the absorptance of the sealing member 4a and the sealing member 4a melted after the temperature reached 660° C., i.e., the melting point of aluminum.

In order to achieve a continuous melting state, the intensity of the reflection 6b from the sealing member 4a was measured with the detector unit 5c, and the correction value was calculated in the computing unit 5d. The laser power was then controlled by the laser controlling unit 5b on the basis of the calculated value so that the reflectance for the laser beam 6a (the ratio of the intensity of the reflection 6b to the intensity of the laser beam 6a) was beyond the threshold value. Since prior experiments discovered that a favorable melting state was obtained at a reflectance of 90% or more, 90% was set as the threshold. As a result, the reflectance of the sealing member 4a could be adjusted to 90% or higher in all parts by varying the power of the laser beam 6a by about 15%, and satisfactory airtight joining could be achieved.

In this example, the melting state of the sealing member 4a was optimized by increasing or decreasing the power of the laser beam 6a. Alternatively, the scanning rate of the laser beam 6a may be adjusted. In such a case, since the relative speed between the laser beam 6a and the sealing member 4a should adjusted, the first substrate 1 and the second substrate 2 may be placed on an XY stage and the scanning rate of the XY stage may be adjusted. It should be noted here that in the case where an apparatus is configured so that the laser energy is varied by changing the power of the laser beam as in this example, there is no need to provide a controlling mechanism for the stage system. In contrast, in the case where an apparatus is configured so that the laser energy is varied by changing the scanning rate of the laser beam, there is no need to provide a laser power controlling mechanism including an optical system.

In this example, the temperature of the melted portion was measured during laser irradiation with a noncontact thermometer, and it was confirmed that the temperature of the sealing member differed depending on the position.

In order to confirm the airtightness of the container made by the method of Example 1, a hole formed in the second substrate 2 was used to check the airtightness. As a result, no leakage was confirmed.

### Example 2

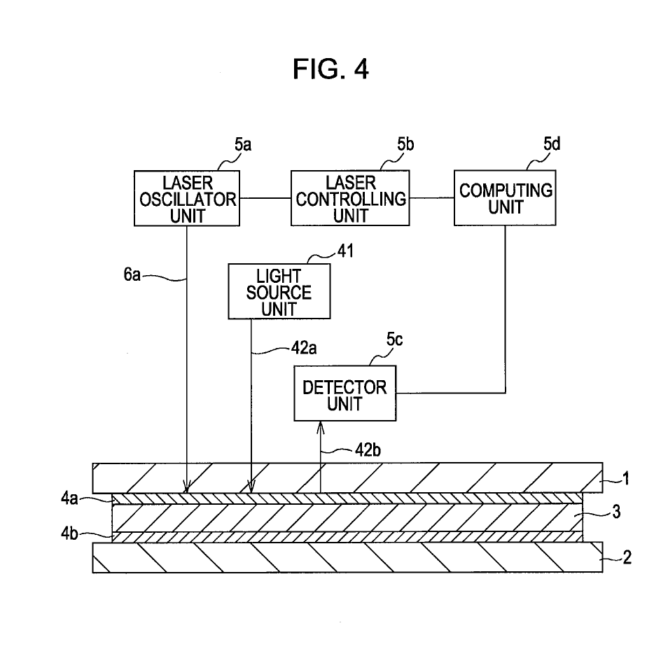

FIG. 4 shows the structure of an apparatus for implementing a method according to Example 2 of the present invention. The same structural units as those of the apparatus of Example 1 are represented by the same reference numerals.

In Example 1 described above, changes in reflectance were detected by using the reflection 6b of the laser beam 6a for melting the sealing member 4a. In contrast, in Example 2, a light source unit 41 for oscillating a laser beam 42a, which was a reference beam for detecting changes in reflectance, was provided separately from the laser oscillator unit 5a. In other words, a plurality of laser oscillator units were used so that a laser beam for melting the joining member is different from a laser beam for detecting the melting state.

In particular, the laser beam 42a (second laser beam) emitted from the light source unit 41 irradiated the portion of the sealing member 4a melted by the laser beam 6a (first laser beam). As a result, a reflection 42b entered the detector unit 5c. The power of the laser beam applied to the sealing member 4a was controlled by adjusting the laser power of the laser oscillator unit 5a on the basis of the information thus obtained so that the reflectance was beyond the threshold value.

Since prior experiments discovered that a favorable melting state was obtained at a reflectance of 90% or more, 90% was set as the threshold. As a result, the reflectance of the sealing member 4a could be adjusted to 90% or higher in all parts by varying the power of the laser beam 6a by about 15%, and satisfactory airtight joining could be achieved.

Since the light source unit 41 for detecting changes in reflectance was provided separately from the laser oscillator unit 5a, the laser beam suitable for melting the sealing member and the laser beam (light source) suitable for measuring the reflectance can be appropriately selected and the detection accuracy can be improved.

In this example, a semiconductor laser (650 nm) was used as the light source unit 41 to detect changes in reflectance.

In order to confirm the airtightness of the container made by the method of Example 2, a hole formed in the second substrate 2 was used to check the airtightness. As a result, no leakage was confirmed.

### Example 3

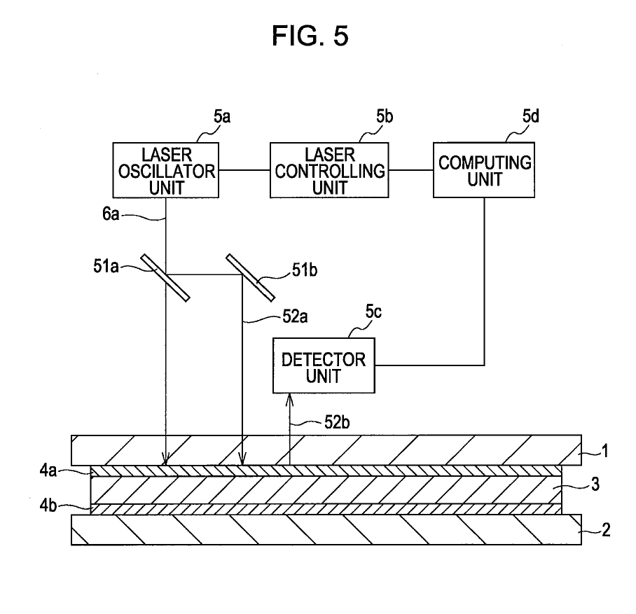

FIG. 5 shows the structure of an apparatus for implementing a method according to Example 3 of the present invention. The same structural units as those of the apparatus of Example 1 are represented by the same reference numerals.

In Example 1 described above, changes in reflectance were detected by using the reflection 6b of the laser beam 6a for melting the sealing member 4a. In contrast, in Example 3, a reference beam 52a for detecting changes in reflectance was formed by splitting the laser beam 6a with a partial reflector mirror 51a. In other words, a laser beam oscillated from the laser oscillator unit 5a was split into a laser beam for melting the joining member and a laser beam for detecting the melting state with a splitting mechanism. According to this structure, the power of the laser beam suitable for melting the joining member and the power of the laser beam (light source) suitable for measuring the reflectance can be selected. Moreover, since only one laser oscillator unit is needed, the structure of the apparatus can be simplified.

To be more specific, the laser beam 6a oscillated in the laser oscillator unit 5a was split into two beams by the partial reflector mirror 51a. The laser beam that passed through the partial reflector mirror 51a irradiated the sealing member 4a.

The laser beam (reference beam 52a) reflected by the partial reflector mirror 51a was reflected by a total reflector mirror 51b to irradiate the melted portion of the sealing member 4a. As a result, a reflection 52b of the reference beam 52a entered the detector unit 5c. The energy of the laser beam applied to the sealing member 4a was controlled by adjusting the scanning rate of the laser beam so that the reflectance was beyond the threshold value.

Since prior experiments discovered that a favorable melting state was obtained at a reflectance of 90% or more, 90% was set as the threshold. As a result, the reflectance of the sealing member 4a could be adjusted to 90% or higher in all parts by varying the scanning rate of the laser beam by about 15%, and satisfactory airtight joining could be achieved.

In this example, the temperature of the melted portion was measured during laser irradiation with a noncontact thermometer, and it was confirmed that the temperature of the sealing member differed depending on the position.

In order to confirm the airtightness of the container made by the method of Example 3, a hole formed in the second substrate 2 was used to check the airtightness. As a result, no leakage was confirmed.

### Example 4

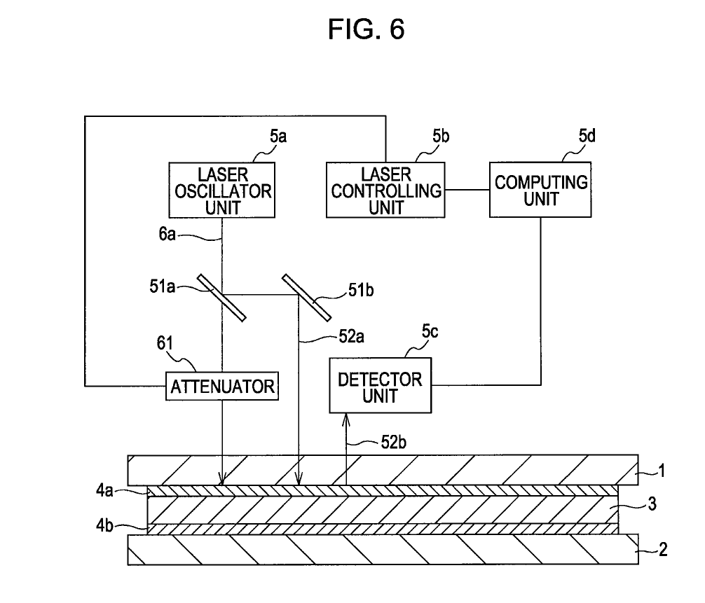

FIG. 6 shows the structure of an apparatus for implementing a method according to Example 4 of the present invention. The same structural units as those of the apparatus of Example 3 are represented by the same reference numerals.

In Example 3, the scanning rate of the laser beam was adjusted to control the laser energy. In contrast, in Example 4, the power of the laser beam 6a irradiating the sealing member 4a was adjusted with an attenuator 61 to control the laser energy applied to the sealing member 4a.

In Example 4, a continuously variable neutral density (ND) filter was used as the attenuator 61.

To be more specific, of the two laser beams formed by splitting, the laser beam reflected by the partial reflector mirror 51a functioned as the reference beam 52a, was reflected by the total reflector mirror 51b, and was applied to the melted portion of the sealing member 4a. As a result, a reflection 52b of the reference beam 52a entered the detector unit 5c. The energy of the laser beam applied to the sealing member 4a was controlled by adjusting the attenuator 61 on the basis of this information so that the reflectance was beyond the threshold value.

Since prior experiments discovered that a favorable melting state was obtained at a reflectance of 90% or more, 90% was set as the threshold. As a result, the reflectance of the sealing member 4a could be adjusted to 90% or higher in all parts by varying the power of the laser beam applied to the sealing member 4a by about 15% using the attenuator 61, and satisfactory airtight joining could be achieved.

In this example, the temperature of the melted portion was measured during laser irradiation with a noncontact thermometer, and it was confirmed that the temperature of the sealing member differed depending on the position.

In order to confirm the airtightness of the container made by the method of Example 4, a hole formed in the second substrate 2 was used to check the airtightness. As a result, no leakage was confirmed.

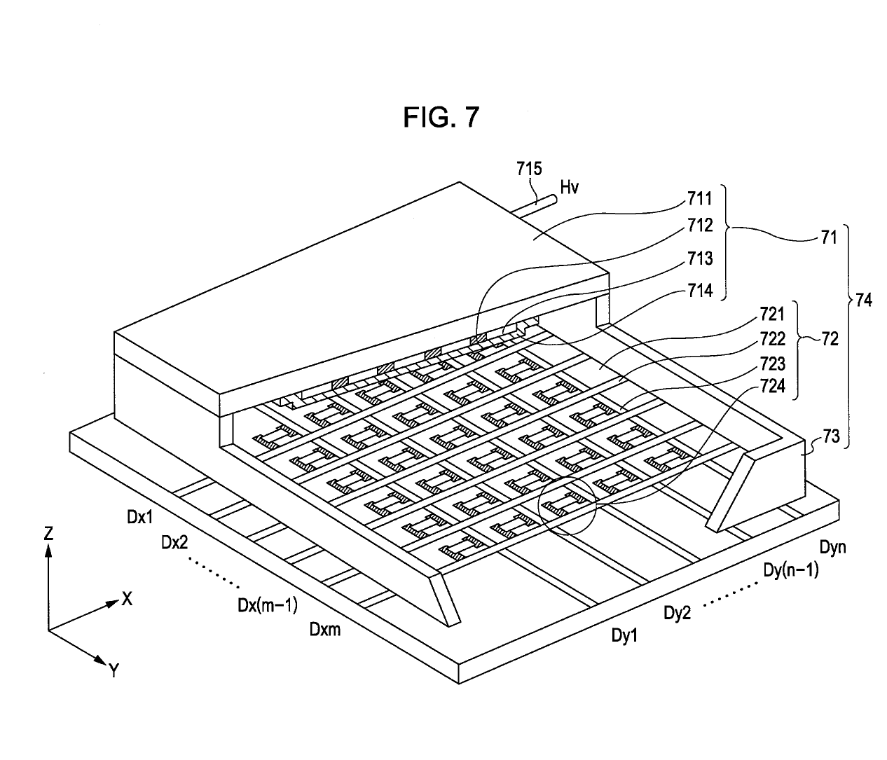

FIG. 7 is a perspective partially cutaway view showing an image-forming apparatus prepared by any one of the methods of Examples described above.

An image-forming apparatus 74 shown in the drawing includes a face plate 71, a rear plate 72, and a sidewall 73.

A black stripe 712 and a phosphor 713 are provided on a glass substrate 711 at the lower surface side of the face plate 71 (the side facing the rear plate 72), and a metal back (acceleration electrode) 714, i.e., a conductive component, is formed on the surface of the phosphor 713.

The rear plate 72 includes row-direction leads 722, column-direction leads 723, an interelectrode insulating layer (not shown), and electron-emitting elements 724 which are formed on a glass substrate 721.

Each electron-emitting element 724 is a surface conduction electron-emitting element in which a conductive thin film having an electron-emitting portion is connected between a pair of element electrodes. In this example, N×M surface conduction electron-emitting elements are connected to a matrix wiring constituted by M row-direction leads 722 and N column-direction leads 723 respectively formed at regular intervals so as to form a multi electron beam source. In this example, the row-direction leads 722 are positioned above the column-direction leads 723 with the interelectrode insulating layer (not shown) provided between the row-direction leads 722 and the column-direction leads 723. Scanning signals are applied to the row-direction leads 722 through extractor terminals Dxl to Dxm and modulation signals (image signals) are applied to the column-direction leads 723 through extractor terminals Dyl to Dyn.

The metal back 714 is provided to accelerate electrons emitted from the electron-emitting elements 724 on the rear plate 72 so as to extract electrons. High voltage is applied from a high-voltage terminal 715 so that the metal back 714 has a high potential when compared with the row-direction leads 722. In such a display panel including the surface conduction electron-emitting elements described above, a difference in potential of about 5 to 20 kV is usually formed between the row-direction leads 722 and the metal back 714.

A sealing member was placed on the sidewall 73, and the face plate 71 was joined to the sidewall 73 by using any one of the methods of Examples 1 to 4.

In this example, the temperature of the melted portion was measured during laser irradiation with a noncontact thermometer, and it was confirmed that the temperature of the sealing member differed depending on the position.

Subsequently, the interior of the image-forming apparatus 74 was vacuumed to provide hermetical seal.

An image was displayed in the image-forming apparatus 74 prepared as above by using a driving circuit (not shown) for conducting television display on the basis of the National Television Standards Committee (NTSC) television signals. The image could be satisfactorily displayed without discharge that would occur by a decrease in degree of vacuum.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-294266 filed Nov. 13, 2007, which is hereby incorporated by reference herein in its entirety.

What is claimed is:

1. A method for making an airtight container including a first substrate, a second substrate, and a frame member, the method comprising the steps of:
irradiating a sealing member disposed between the first substrate and the frame member with a laser beam;
determining a melting state of the sealing member on the basis of a reflection of the laser beam reflected by the sealing member; and
joining the first substrate to the frame member with the sealing member by controlling laser energy of the laser beam incident upon the sealing member per unit area based on a determination of the melting state of the sealing member.

2. A method for making an airtight container including a first substrate, a second substrate, and a frame member, the method comprising the steps of:
irradiating a sealing member disposed between the first substrate and the frame member with a first laser beam and a second laser beam;
determining a melting state of the sealing member on the basis of a reflection of the second laser beam reflected by the sealing member; and
joining the first substrate to the frame member by controlling laser energy of the first laser beam incident upon the sealing member per unit area upon a determination of the melting state of the sealing member.

3. The method according to claim 1, wherein the melting state of the sealing member is determined on the basis of changes in the reflectance at a joining portion irradiated with the laser beam.

4. The method according to claim 2, wherein the melting state of the sealing member is determined on the basis of changes in the reflectance of a joining portion irradiated with the second laser beam.

5. The method according to claim 2, wherein the first laser beam and the second laser beam are respectively emitted from different laser oscillator units.

6. The method according to claim 2, wherein a laser oscillator emits a laser beam that intersects a splitting mechanism to form a first laser beam and a second laser beam.

7. The method according to claim 1, wherein, in the step of irradiating the sealing member with the laser beam, irradiation of the sealing member is conducted while scanning the laser beam, and the energy of the laser beam incident upon the sealing member is controlled by changing the scanning rate of the laser beam.

8. The method according to claim 2, wherein, in the step of irradiating the sealing member with the laser beam, irradiation of the sealing member is conducted while scanning the first and second laser beams, and the energy of the laser beam incident upon the sealing member is controlled by changing the scanning rate of the first laser beam.

9. The method according to claim 1, wherein the energy incident on the sealing member is controlled by varying power of the laser beam.

10. The method according to claim 2, wherein the energy incident on the sealing member is controlled by varying power of the first laser beam.

11. The method according to claim 1, wherein reflectance of the laser beam is greater than or equal to a threshold value.

12. The method according to claim 2, wherein a ratio of the intensity of the reflection of the second laser beam to the intensity of the first laser beam is greater than a threshold value.

13. The method according to claim 2, wherein the energy of the first laser beam incident on the sealing member is varied by an attenuator.

14. A method for making an airtight container including a first substrate, a second substrate, and a frame member, the method comprising the steps of:
irradiating a sealing member disposed between the frame member and a selected one of the first and second substrates with a laser beam split into a first laser beam and a second laser beam;
melting the sealing member with the first laser beam;
determining a melting state of the sealing member on the basis of a reflection of the second laser beam reflected by the sealing member; and
joining the selected substrate to the frame member by controlling laser energy of the laser beam incident upon the sealing member per unit area based on a determination of the melting state of the sealing member.

15. The method according to claim 14, wherein the melting state of the sealing member is determined on the basis of changes in the reflectance at a joining portion irradiated with the second laser beam.

16. The method according to claim 14, wherein the energy incident on the sealing member is controlled by varying power of the first laser beam.

17. The method according to claim 14, wherein a ratio of the intensity of the reflection of the second laser beam to the intensity of the first laser beam is greater than a threshold value.
